(19) United States
(12) Patent Application Publication
(10) Pub. No.: US 2010/0268646 A1
(43) Pub. Date: Oct. 21, 2010

(54) Electronic Registration And Transaction System

(76) Inventor: David Erickson, Excelsior, MN (US)

Correspondence Address: INSKEEP INTELLECTUAL PROPERTY GROUP, INC, 2281 W. 190TH STREET, SUITE 200, TORRANCE, CA, 90504, US

(21) Appl. No.: 12/726,316

(22) Filed: Mar. 17, 2010

Related U.S. Application Data
(63) Continuation of application No. 11/877,512, filed on Oct. 23, 2007, now abandoned.
(60) Provisional application No. 60/951,083, filed on Jul. 20, 2007.

(51) Int. Cl. G06Q 40/00; G06Q 20/00; G06Q 50/00; G06F 15/16

(52) U.S. Cl. 705/44; 709/203

(57) ABSTRACT

One preferred embodiment provides mobile device based registrations and transactions by providing an aggregator, in the form of a server connected to the internet for collecting and selectively distributing user data. The aggregator may obtain the user data through the mobile network operator, a third party data source (e.g., a credit reporting bureau), or from one-time user input with the aggregator. The user can selectively transmit their user data quickly (e.g., with the selection of a single link) via their mobile device between the aggregator and a third party content provider (e.g., a gambling site, adult content site, banking site, etc.).

### RELATED APPLICATIONS

The present application is a continuation of U.S. patent application Ser. No. 11/877,512, filed Oct. 23, 2007, entitled Electronic Registration And Transaction System, which claims benefit of U.S. Provisional Application Serial No. 60/951,083 filed Jul. 20, 2007 entitled eWallet, both of which are hereby incorporated herein by reference.

### BACKGROUND OF THE INVENTION

Improved mobile device technology has facilitated the distribution of a wide range of all manner of content by Mobile Network Operators (MNOs). For example, MNOs now provide users with access to ring tones, music, games, TV shows, movies, and gambling.

Typically, MNOs provide this content through a proprietary software portal that is easily accessible from a mobile device, also known as providing content “on deck”. In this respect, the user is directed to third party content via the MNOs portal. Alternately, users may also access content solely through an internet browser (e.g., Safari) and internet connection on their phone, which is known as providing content “off deck” or direct to consumer. In this scenario, users navigate the internet to find third party content.

On deck content delivery can greatly simplify some mobile device transactions. For example, a user may easily purchase ringtones, music, games, TV and some movies by simply navigating to the content through the on deck portal and selecting the content. The MNO later charges the user for the purchase on their mobile device bill. However, not all content can be easily selected and purchased. For example, accessing age-restricted content often requires a user to fill out long registration forms, partly to prove the age of the purchaser. In another example, gambling sites require similar registration, also, in part, to verify the age of the user. These long registration forms are difficult and time consuming to complete on a mobile device, especially since many mobile devices do not have traditional keyboards.

In a more specific example, some gambling sites require the user to input the following information fields: title, first name, last name, date of birth, gender, email address, postcode, house name, street, city, county, country, credit card type, expiration date, CVV2, start date, issue number, credit card number and MSISDN.

Some portals, such as gambling or bank portals typically require the transfer of large sums of money by the user. Such financial transactions are usually not possible or desirable through the billing systems of an MNO, so the user must also provide detailed financial data for each transaction related portal (e.g., gambling site) used.

Further, different countries often have different complex laws regulating financial transactions. Therefore it can be difficult for content providers to comply with such regulations.

Thus, financial and registration data provides a significant barrier for both users and content providers.

### SUMMARY OF THE INVENTION

In a preferred embodiment, the present invention facilitates mobile device based registration and transactions by providing an aggregator, in the form of a server connected to the internet for collecting and selectively distributing user data, such as registration data or financial data. The aggregator may obtain the user data through the mobile network operator, a third party data source (e.g., a credit reporting bureau), or from one-time user input with the aggregator. The user can selectively transmit their user data quickly (e.g., with the selection of a single link) via their mobile device between the aggregator and a third party content provider (e.g., a gambling site, adult content site, banking site, etc.).

### BRIEF DESCRIPTION OF THE DRAWINGS

FIG. 1 illustrates a conceptual view of a data aggregation system according to according to a preferred embodiment of the present invention;

FIG. 2 illustrates a conceptual view of a data aggregation system according to according to a preferred embodiment of the present invention;

FIG. 3 illustrates a flow chart of a method of determining an identification of a mobile device according to a preferred embodiment of the present invention;

FIG. 4 illustrates a flow chart of a method of providing registration and financial information according to a preferred embodiment of the present invention;

FIG. 5 illustrates a conceptual view of mobile device navigation through a gambling site according to a preferred embodiment of the present invention;

FIG. 6 illustrates a flow chart of a method for determining an appropriate transaction type according to a preferred embodiment of the present invention;

FIG. 7 illustrates a conceptual view of transmissions from a data aggregation system according to a preferred embodiment of the present invention;

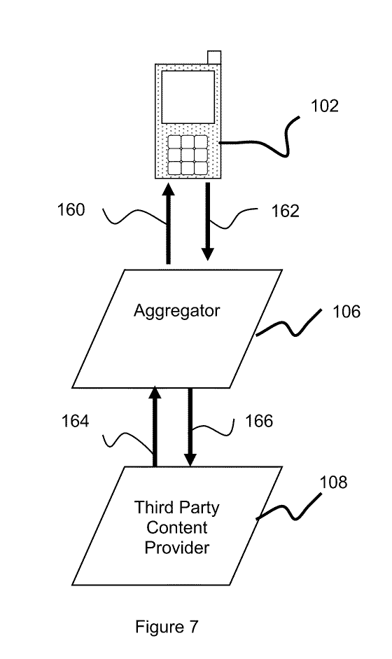

FIG. 8 illustrates a conceptual view of communications between servers with a mobile device according to a preferred embodiment of the present invention;

FIG. 9 illustrates a conceptual view of a method for event-triggered transactions with a mobile device according to a preferred embodiment of the present invention; and,

FIG. 10 illustrates a conceptual view of a method for collecting event-triggered user data according to a preferred embodiment of the present invention.

### DETAILED DESCRIPTION OF THE INVENTION

The term mobile device used in this application generally includes hand-held electronic devices including a display, an input and a wireless transceiver (e.g., CDMA, Wifi or Bluetooth) capable of sending and receiving communications such as voice or data and recording or displaying the voice or data over a wireless network. Specific examples include cell phones which generally include a numeric keypad and a display, a PDA which generally includes a touch screen display and miniature keyboard, a pager which generally includes a small display and a plurality of navigational buttons and a personal media player (e.g., Ipod or Zune) which generally include a display and navigational buttons.

A wireless network generally includes any communication network or wireless technology platform which is, or can be used by a mobile device to access data from another location, such as a computer server.

Wireless technology or wireless technology platforms generally include any technology that permits the receipt of content such as voice or data through the use of mobile devices. For example, wireless technology may include technologies used in the General Packet Radio Services (GPRS), Global System for Mobile Communications (GSM), Personal Communications Networks (PCN), I-Mode, Code Division Multiple Access CDMA and CDMA 2000, Time Division Multiple Access (TDMA), Tetra, Wireless-Ian, Wireless Application Protocol (WAP) and Universal Mobile Telecommunications System (UMTS), DVB-H (Digital Video Broadcasting-HandHeld), WI-Fl (including its developments, such as WI-MAX)], and the Portal and their updates, developments, derivations (including each component of the Fixed Line of each system), all together or combinations thereof. In a further example, content includes text messages, data, voices, video, images and multimedia services on a mobile device.

The term mobile network operator (MNO) generally includes any type of mobile phone operator, such as any person who holds a license for the provision of mobile telecommunication services in a territory or who provides services to its clients via wireless technology within a territory using the network of a primary license of a primary license holder, such as a mobile virtual network operator.

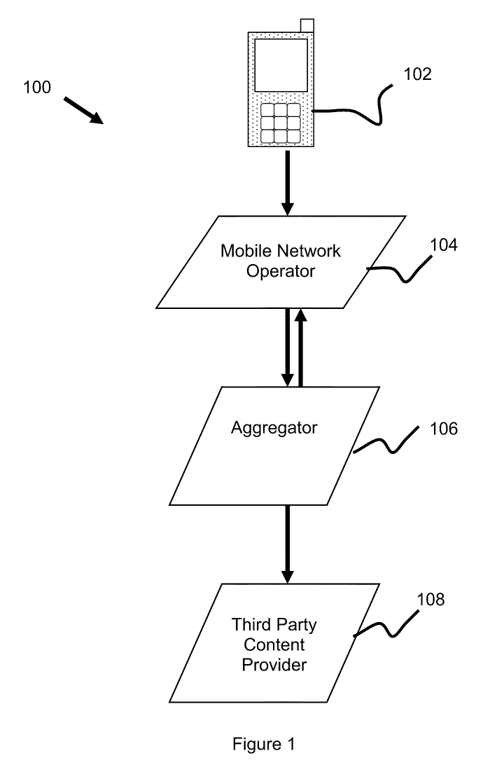

FIG. 1 illustrates a preferred embodiment of a method and system for aggregating and distributing data 100 in connection with mobile device initiated transactions. Generally, a data aggregator 106 collects and distributes user registration and financial data, allowing a user to selectively release this data to third party content providers 108 via a mobile device 102. In this respect, the aggregator 106 greatly reduces the time and effort associated with manually registering with third party content providers 108 (i.e., requiring the user to manually enter their user data when accessing content).

Further, the user can selectively transfer money by mobile device between the aggregator 106 and various third party content providers 108 or any other organization affiliated with the aggregator 106. For example, users may receive payout from winnings on gambling sites, and then transfer that money to payoff credit card balances. Thus, the aggregator 106 acts like an electronic bank account, enabling the user to perform relatively complex and time consuming financial transactions quickly over a mobile device 102.

More specifically, the user operates their mobile device 102 to display either an on deck portal (e.g., Get It Now or VCast on Verizon Wireless) or an off deck portal (e.g., a web page viewed with Safari). When the user selects content such as gambling or adult media that requires additional information or financial details, the mobile device 102 is directed to a computer server of aggregator 106. Preferably, the aggregator 106 is connected to the internet and contains software for processing web traffic and data as outlined below.

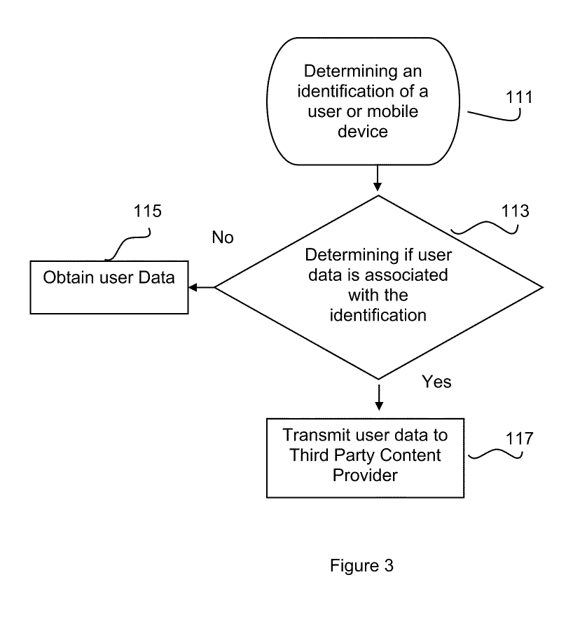

Next, as seen in element 111 of FIG. 3, the aggregator 106 (i.e., the software on the aggregator server) determines the identity of the user or user's mobile device 102. In one example, the user may log in to the aggregator 106 with a user name and password. In another example, the aggregator 106 may detect an identification number of the mobile device 102 such as the mobile device number, the Mobile Subscriber Integrated Services Digital Network Number (MSISDN) or the International Mobile Equipment Identity (IMEI).

Once the identity of the user or mobile device 102 has been determined, the aggregator 106 determines if user data is stored with the aggregator 106 (e.g., on a server) as seen in element 113. As seen in element 117, if user data is present, the user data is either automatically transmitted to the specified content provider or the user is provided a simple transmitting option (e.g., a “Submit Data” button or similar “one click” mechanism). If the aggregator 106 is not in possession of the user data, the data is obtained, as seen in element 115.

As previously described, this data can be registration data or financial data. Thus, the user can selectively transmit registration data needed to register for a site (e.g., register for a gambling site) or financial data for a transaction (e.g., paying a bill, placing a bet on a gambling site, receiving a payout from a gambling site, or depositing cash to the user's bank account).

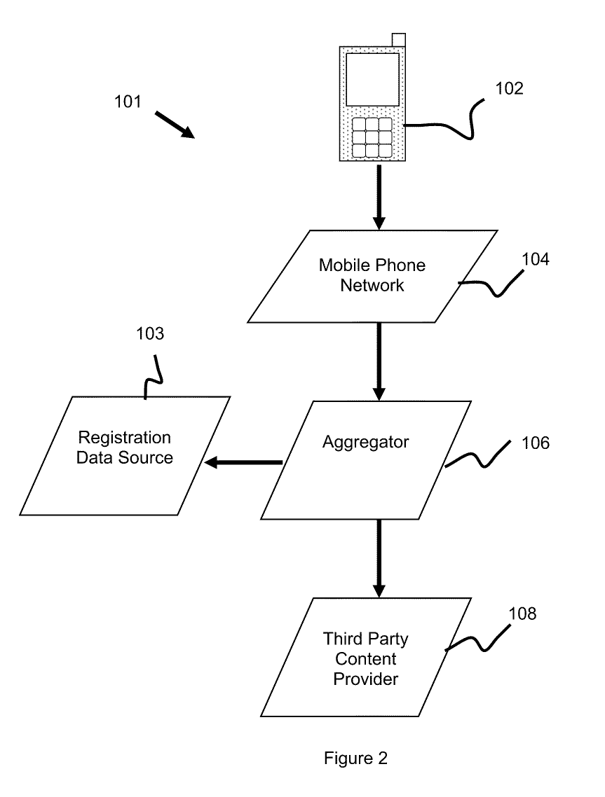

The user data can preferably be obtained by querying a third party database or by allowing the user to manually enter the information in. In one example, the aggregator 106 may query the MNO 104 (as seen with the two way communication arrows in FIG. 1) for user data. In this example, the aggregator 106 may provide a user identification (e.g., mobile device number, name, or mobile device ID number) to the MNO 104 who then transmits the user's data (e.g., name, address, date of birth, etc.). In another example data aggregation system 101 shown in FIG. 2, the aggregator 106 may provide a user identification number (e.g., name or social security number) to a registration data source 103 such as a credit bureau (e.g., Equifax) or financial institution who then provides the desired user data back to the aggregator 106.

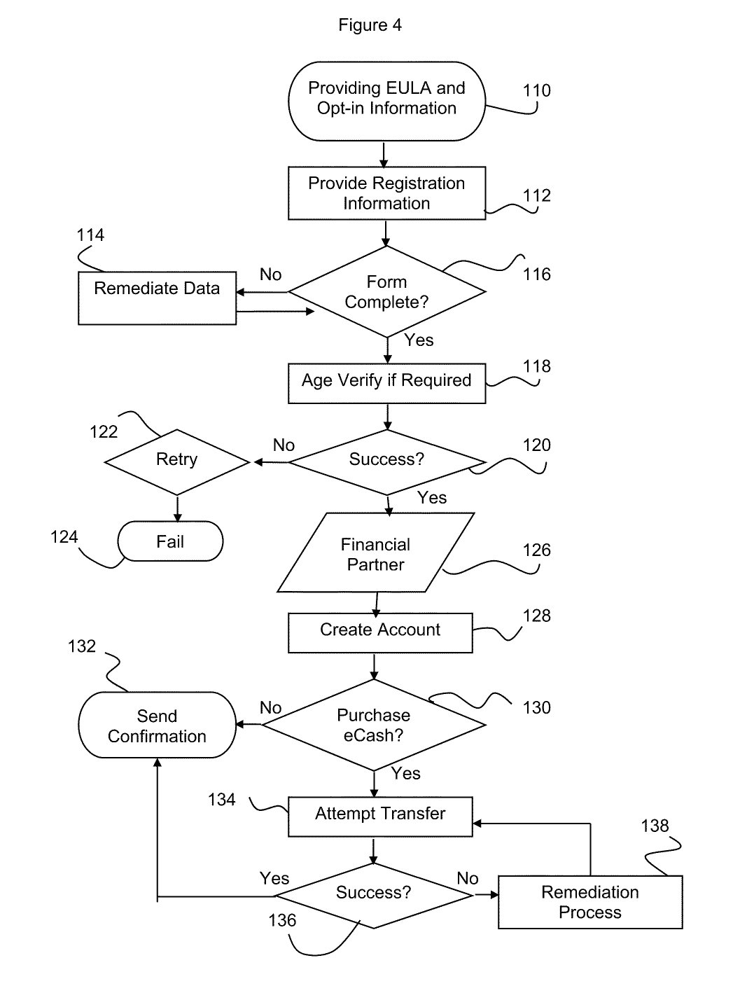

FIG. 4 illustrates an example of a process for manually entering user registration and financial data. Initially, an end user license agreement (EULA) and opt-in information is displayed for the user, as seen in element 110. Next, the user is directed (via their mobile device screen transmitted from the aggregator's servers) to provide specific registration information, such as name, address, telephone number, email address, date of birth, etc., as seen in element 112. This information is submitted from the user's mobile device 102 to the servers of the aggregator 106 which evaluates this submitted information to determine if the data form was completely and properly filled out, as shown in element 116.

If the form is incomplete, the form is presented to the user again, asking the user to provide the wrong or omitted data, as seen in element 114. If the submitted information is complete, the user's age is optionally verified in element 118. If the age verification is not successful (element 120), the verification is retried as seen in element 122 or else fails as seen in element 124.

As seen in element 126, the user enters account details of a financial partner accessible or preferred by the aggregator 106. Optionally, the user can enter information for multiple financial partners, providing the user with multiple payment options for desired transactions (e.g., credit card, debit card, bank routing information, etc.) If the user does not have an account, one can be created with a suggested financial partner, as seen in element 128. Next, the user is provided a choice in element 130 to transfer funds (e.g., eCash) from the financial partner to their account with the aggregator 106.

If the user does not wish to transfer funds to their account with the aggregator 106, the registration process ends with a confirmation message sent to the user (e.g., by text message or email) as seen in element 132. If the user wishes to transfer funds, the aggregator 106 attempts the fund transfer with the financial institution as seen in element 134. As seen in element 136, if the transfer is not successful, the remediation process of element 138 attempts the transfer again. If the transfer is successful, the registration process ends with a confirmation message, as seen in element 132.

Once this information is collected, the aggregator 106 can transfer it to the third party content provider 108, as seen in FIG. 1. For example, the information may be transferred to register for a gambling site, order adult media, transfer money from an account with the aggregator 106 to a bank or transfer money from a bank into an account with the aggregator 106.

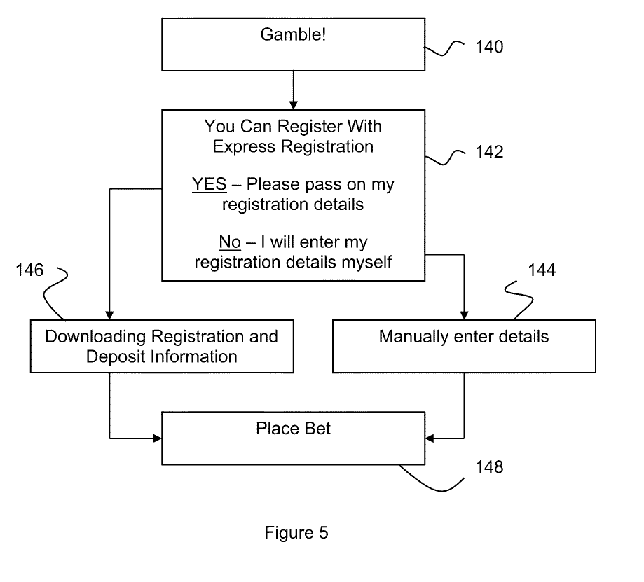

FIG. 5 illustrates a series of example mobile device displays for gambling content provided by a third party content provider 108 according to the present invention. In element 140, the mobile device displays (i.e., downloads) an introductory screen showing the name of the gambling site. In element 142, the mobile device displays a registration choice, asking the user to automatically pass on their registration details (either previously presented to the aggregator 106 as described in FIG. 4 or obtained from a registration data source). Thus, the user can choose to manually enter their data (element 144) or have the aggregator 106 automatically send on their registration details on to the third party content provider 108 (element 146). Finally, the user can begin gambling and placing bets, as seen in element 148.

Often, users wish to visit many different content provider's sites. For example, some gambling sites offer different gambling options or better odds for different games, so a user may prefer to visit many different sites. Manually entering in registration details on a mobile device requires a large amount of time, often discouraging the user from trying a site or content provider. However, by providing these registration details to the aggregator 106, the user can simply use a single click (i.e., choosing one link on their mobile device) to transmit all of their relevant details to a third party content provider associated with the aggregator 106.

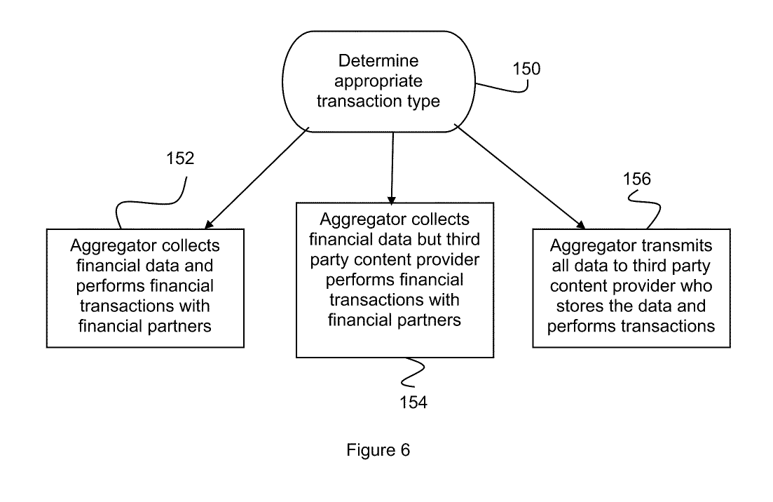

FIG. 6 illustrates a process of determining an appropriate transaction type as performed by the aggregator 106. As previously discussed, different countries have different regulations regarding financial transactions. These regulations can be difficult for a third party content provider to comply with, especially when targeting customers in many different countries. Often, a financial transaction method dictated by one country will be insufficient for complying with a second country's regulations.

As seen in element 150, when the user selects the aggregator 106 for use with a third party content provider 108, the aggregator 106 determines the transaction type appropriate to abide by the financial regulations of a specific country. Some factors to be considered, for example, are the country location of the user, the country location of the third party content provider 108, and the size of the transaction. Based on these factors, a type of transaction is selected and performed. For example, element 152 illustrates a transaction in which the aggregator collects financial data (e.g., financial institution number, account number, etc.) then conducts the desired transaction for the third party content provider 108. In another example seen in element 154, the aggregator 106 collects and stores the user's financial data, but transmits this data to the third party provider 108 to perform the financial transaction. However, the third party provider 108 does not store the user's financial information. In yet another example, the aggregator 106 transmits the user's financial data to the third party content provider 108 once. The content provider 108 then stores this data for future transactions.

In this respect, the third party content providers 108 can rely on the aggregator 106 to select the appropriate transaction method, allowing the content provider 108 to access mobile device markets in many different countries.

Another problem presented to third party content providers 108 is the variations in mobile device displays and internet browsers. Hundreds of different mobile device models are presently in use, most of which have varying screen sizes and limited browsing capabilities (e.g., they lack advanced browsing capabilities such as Macromedia Flash). Thus, each type of mobile device can display mobile device display data differently. Unless a content provider is aware of these differences, their mobile device display data (e.g., a web page) will not display properly.

Referring to FIG. 5, the aggregator 106 simplifies the content display process for a third party content provider 108 by determining the resolution and capabilities of the mobile device 102, then formatting the mobile device display data provided by the third party content provider 108. In other words, the aggregator 106 acts as an intermediate agent between the mobile device 102 and the third party content provider 108 to properly format mobile device display data to properly display on a mobile device.

More specifically, the mobile device 102 transmits identification information 162 (e.g., phone manufacture and model) to the aggregator 106 which determines the display and functionality restrictions of the mobile device 102. The third party content 164 is transmitted to the aggregator 106 in xml or a similar format with minimal formatting data. The aggregator 106 then formats the data sent by the third party content provider 108 and transmits the formatted data 160 to the mobile device 102. Further communications 166 are transmitted back to the third party content provider 108, preferably xml or a similar widely recognized and simply formatted format. In this respect, the third party content provider 108 can provide content to a wide variety of mobile devices 102 without the need to format their content specifically for each phone 102.

While the previously described examples describe user initiated transactions (e.g., a user initially navigates to a mobile display page such as a web page), it is also contemplated that the aggregator 106 can initiate actions on the mobile device 102 based on an event related to user data accessible by the aggregator 106.

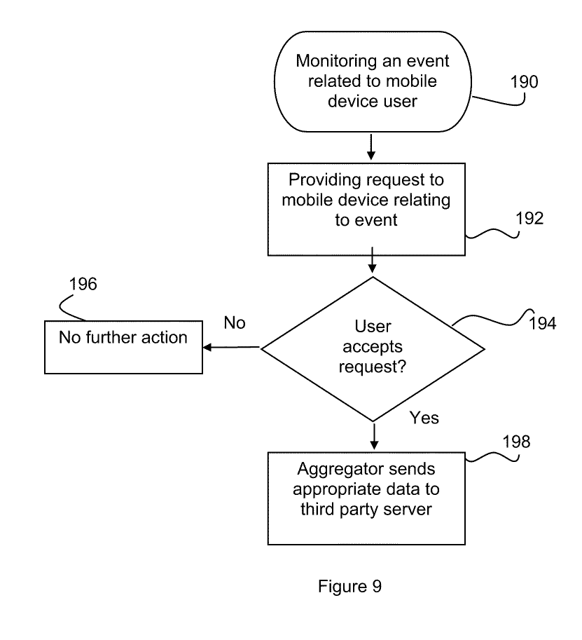

As illustrated in FIG. 9, predetermined events relating to a user are monitored, as seen in element 190. For example, the aggregator 106, may monitor predetermined events or a third party content provider 108 may monitor predetermined events and then notify the aggregator 106 when an event occurs. Example events may include the release of a downloadable movie, a sporting event, a stock market price drop or a video game release.

Next, as seen in element 192, the aggregator 106 transmits mobile display page data that displays a request to the user relating to the event. Preferably, the aggregator 106 can allow this display page data to automatically display on the mobile device (e.g., automatically executing a web browser, display program, or similar program located on the mobile device). The mobile display page data also includes simple selections (e.g., hypertext links providing an “accept” or “deny” command) to agree to or dismiss the offer presented to the user. For example, a webpage may be transmitted asking the user if they would like to download a new movie release with a favorite actor. If the user wishes to download the movie, they can select a “buy” hypertext link. If the user does not desire to purchase the movie, a “No thanks” link can be selected, dismissing the web page.

Referring to element 194, if the user does not accept the request, no further action is taken on behalf of the user, as seen in element 196. Optionally, a decline to the request may be transmitted back to the aggregator 106. However, if the user accepts the request (e.g., by selecting a hypertext link indicating acceptance), the acceptance is communicated to aggregator 106.

In some situations, the aggregator may be in possession of the content requested by the user (e.g., a coupon or media file) and will thereby initiate a transaction. If the aggregator 106 is not in possession of the requested content, the aggregator sends the appropriate registration and/or financial data to the third party content provider 108, as seen in element 198 and as described elsewhere in this application. The third party content provider 108 either directly transmits the requested content to the user's mobile device or provides the content to the aggregator 102 who then provides the content to the user's mobile device 102.

Preferably, the aggregator 106 maintains a database containing events that will trigger the process set forth in FIG. 9. For example, the database may include an actor's name, a sports team, a race, a stock price change, etc.

In one specific example, the aggregator 106 is aware (e.g., via a database entry) that a user has previously placed bets on a certain sports team. The aggregator 106 monitors sports schedules for the specified team, then initiates and transmit mobile device display page data (e.g., automatically displaying a web page or a popup message on the mobile device 102) shortly before that team plays. The mobile device display asks the user if they would like to bet on that sports team. If the user agrees, the aggregator 106 contacts the third party content provider 108 (e.g., a gambling site) and places a bet with the user's registration and financial information, as previously described in this specification.

In another example, if the aggregator 106 is aware that a user has previously downloaded (or has otherwise indicated a preference for) movies starring a specific actor, the aggregator 106 may initiate and transmit mobile device display data to the user when a new movie with that actor is available. The page data may ask the user if they would like to purchase and download the movie. If the user agrees, the aggregator 106 contacts the third party content provider 108 (e.g., a movie sales site) and provides the user's registration and financial data to complete the movie transaction. Finally, the aggregator 106 provides additional mobile device display page data that directs the user to the movie download address or alternately pushes the movie directly to the user's mobile device 102 (i.e., copies the movie to the mobile device without further input from the user).

In another example, the aggregator 106 may monitor a predetermined stock for a user. If the stock value reaches a certain level, a request may be sent to the user's mobile device 102 that asks a user to buy or sell that stock. The user may accept or decline the offer, and may also be provided with an “amount” text box to determine an amount of stock to buy or sell.

In yet another example, the event triggering a request by the aggregator 106 may be location data from the user's mobile device 102. Many mobile devices 102 now include location tracking mechanisms, such as GPS receivers, which allow the mobile device 102 to determine a user's location. The mobile device 102 may include software installed by the aggregator 106 which periodically transmits location information to the aggregator 106. When the aggregator 106 determines that the mobile device 102 is within a predetermined proximity to a third party business, the aggregator 106 may initiate and transmit mobile device display page data to the user. The mobile device display data may include information on sale items at the business, personalized coupons (e.g., a coupon that displays a bar code on the user's mobile device display and can be scanned by a register at the business).

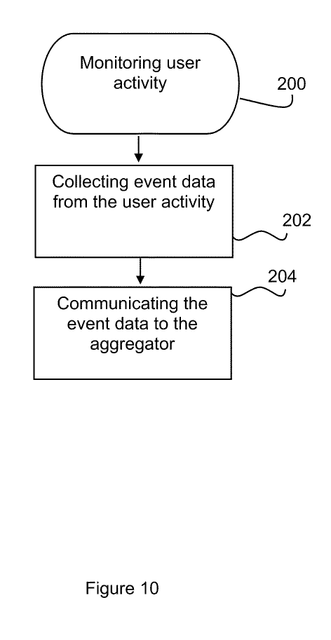

As seen in FIG. 10, triggering events are preferably collected from devices associated with a user's behavior (e.g., a cell phone, cable or satellite TV tuner equipment, etc.). Referring to element 200, software located on the user's device monitors data related to the user. Next, as seen in element 202, the software collects and stores relevant portions of this event data in a user data file (e.g., keywords from internet searches and web sites visited). Finally, as seen in element 204, the software communicates the user data file to the aggregator 104 which uses the triggering event data in the user data file as previously described.

In one example, the user's cell phone may contain software that monitors internet related data on the cell phone (e.g., web addresses, search terms, words in emails, etc.), phone numbers called, and/or gps coordinates of locations visited, and then stores the data in a user information data file. Finally, the software on the cell phone transmits this data to the aggregator 108 who then monitors the user's activity for triggering events based on this user data as previously described in this specification.

In another example, a cable (or alternately satellite) TV tuner box includes software that monitors the programs and related program data (e.g., actors, directors, producers, writers, genera, etc.) and stores this data in a user information data file. The user information data file is communicated to the aggregator 104 which monitors the user's activity for triggering events based on the user data within the user information data file.

In another example, a user's computer includes software that monitors internet activities on the computer (e.g., web addresses, search terms, words in emails, etc.), and then stores the data in a user information data file. Finally, the software on the computer transmits this data list to the aggregator 108 who then monitors the user's activity for triggering events based on this user data as previously described in this specification.

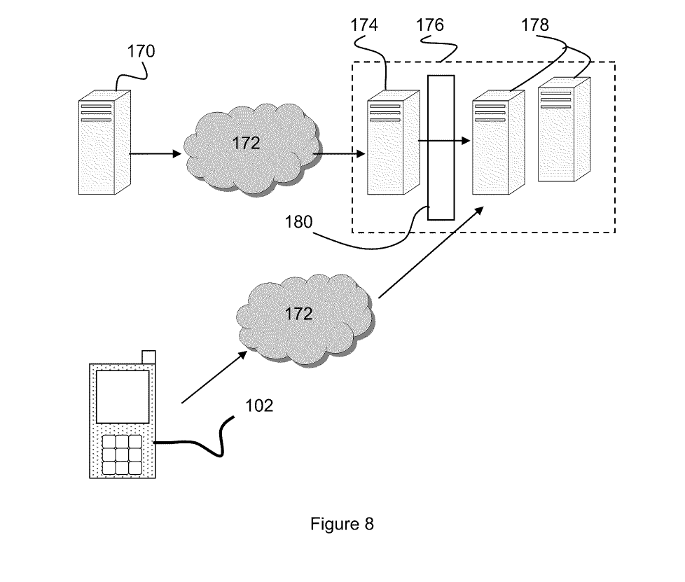

In a preferred embodiment seen in FIG. 8, the functions of the aggregator 104 are performed with software located on servers 178 connected to the internet 172. Preferably, a dedicated server 174 belonging to the MNO 104 is located at the same location 176 and on the same intranet as the aggregator servers 178, allowing the main MNO servers 170 to selectively transfer data to the dedicated server 174. Preferably, the MNO dedicated server 174 and the aggregator servers 178 are connected via a firewall 180 to provide further security and privacy protection of the sensitive user data. In this respect, the MNO 104 can selectively transfer user data (e.g., via ftp) to the MNO dedicated server 174 to minimize security issues with the user's data.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A method of transferring data with a mobile device comprising:
executing software stored on a computer readable medium on at least a first server;
navigating with a mobile device to a mobile device display page provided by a second server;
detecting a unique identifier associated with the operation of said mobile device;
providing said software on said first server with said unique identifier;
determining a user identity based on said unique identifier by said software on said first server;
determining with said software of said first server if registration information and financial information is accessible to said software of said first server;
accepting user inputted registration information from said mobile device to said software executed on said first server if said registration information is unavailable to said software of said first server;
accepting financial account information from said mobile device to said software executed on said first server if said financial information is unavailable to said software of said first server;
communicating said registration data from said software of said first server to said second server;
determining with said software a geographic location of said second server;
determining with said software a geographic location of said mobile device;
determining with said software a monetary size of a financial transaction;
selecting a transaction type based on financial laws of said geographic location of said second server and said geographic location of said mobile device;
authorizing said financial transaction with said mobile device to an account associated with said second server;
transferring a sum of money to an account associated with said second server in compliance with said financial laws of said geographic location of said second server and said geographic location of said mobile device; and,
granting access to a service provided by said second server to said mobile device based on said transferring said sum of money and said communicating said registration data.

2. The method of claim 1 wherein said unique identifier is a Mobile Subscriber Integrated Services Digital Network Number.

3. The method of claim 1 wherein said unique identifier is a Mobile Equipment Identity.

4. The method of claim 1, wherein said unique identifier is a mobile device phone number.

5. The method of claim 1, wherein said accepting user inputted registration information from said mobile device to said software executed on said first server further comprises accepting age verification information.

6. The method of claim 5, wherein said communicating said registration data from said software of said first server to said second server further comprises communicating said age verification information to said second server.

7. A method of transferring data with a mobile device comprising:
executing software stored on a computer readable medium on at least a first server;
navigating with a mobile device to a mobile device display page provided by a second server;
detecting a unique identifier associated with the operation of said mobile device;
providing said software on said first server with said unique identifier;
determining a user identity based on said unique identifier by said software on said first server;
contacting a mobile network operator server with said software executed on said first server;
obtaining user registration information by said software executed on said first server from said mobile network operator server with said software executed on said first server;
obtaining financial account information by said software executed on said first server from said mobile network operator;
communicating said registration data from said software of said first server to said second server;
authorizing a financial transaction with said mobile device to an account associated with said second server;
transferring a sum of money to an account associated with said second server; and,
granting access to a service provided by said second server to said mobile device based on said transferring said sum of money and said communicating said registration data;
determining with said software on said first server a resolution of said mobile device;
determining with said software on said first server capabilities of a browser on said mobile device;
receiving display data from said second server with said software on said first server;
formatting said display data to a formatted display data according to said resolution and capabilities of said mobile device; and,
transmitting said formatted display data to said mobile device.

8. The method of claim 7 wherein said unique identifier is a Mobile Subscriber Integrated Services Digital Network Number.

9. The method of claim 7 wherein said unique identifier is a Mobile Equipment Identity.

10. The method of claim 7, wherein said unique identifier is a mobile device phone number.

11. The method of claim 7, wherein said obtaining user registration information by said software executed on said first server from said mobile network operator server with said software executed on said first server further comprises obtaining age verification information.

12. The method of claim 11, wherein said communicating said registration data from said software of said first server to said second server further comprises communicating said age verification information to said second server.

13. A method of transferring data with a mobile device comprising:
executing software stored on a computer readable medium on at least a first server;
navigating with a mobile device to a mobile device display page provided by a second server;
detecting a unique identifier associated with the operation of said mobile device;
providing said software on said first server with said unique identifier;
determining a user identity based on said unique identifier by said software on said first server;
communicating with a credit bureau server with said software executed on said first server;
obtaining user registration information by said software executed on said first server from said credit bureau server with said software executed on said first server;
obtaining financial account information by said software executed on said first server from said mobile network operator;
communicating said user registration from said software executed on said first server to said second server;
determining with said software a geographic location of said second server;
determining with said software a geographic location of said mobile device;
determining with said software a monetary size of a financial transaction;
determining financial transaction regulations based on said geographic location of said second server and said geographic location of said mobile device;
authorizing a financial transaction with said mobile device to said second server;
transferring a sum of money according to said financial transaction regulations and according with the financial laws of the geographic location of the second server and the geographic location of the mobile device; and,
granting access to a service provided by said second server to said mobile device based on said transferring said sum of money.

14. A system for transferring data with a mobile device comprising:
software executable from a computer readable medium on at least a first server;
a second server configured to display a web page to a mobile device;
a means for determining a unique identifier of said mobile device;
wherein said software determines, based on said unique identifier of said mobile device, if registration information and financial information is accessible to said software;
wherein said software accepts user-inputted registration information from said mobile device if said registration information is unavailable to said software of said first server;
wherein said software accepts user-inputted financial information from said mobile device if said financial information is unavailable to said software of said first server;
wherein said software communicates said registration data to said second server;
wherein said software determines a geographic location of said mobile device, determines a geographic location of said second server, determines a monetary size of a financial transaction, selects a transaction type based on financial laws of the geographic location of the second server of the geographic location of the mobile device, and conducts a transaction including transferring a sum of money to an account associated with said second server;
wherein said second server is further configured to grant access to a service provided by said second server to said mobile device based on said transferring said sum of money, communicating said financial information and registration information.
